(19) United States
(12) Patent Application Publication
(10) Pub. No.: US 2026/0112270 A1
(43) Pub. Date: Apr. 23, 2026

(54) AUTOMATED VALET PARKING SYSTEM AND AUTOMATED VALET PARKING METHOD

(71) Applicant: TOYOTA JIDOSHA KABUSHIKI KAISHA, Toyota-shi (JP)

(72) Inventors: Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/278,196

(22) Filed: Jul. 23, 2025

(30) Foreign Application Priority Data
Oct. 21, 2024 (JP) 2024-185081

(51) Int. Cl. G08G 1/14; B60L 58/12; B60W 30/06

(52) U.S. Cl. CPC G08G 1/145; B60L 58/12; B60W 30/06; B60L 2240/665; B60W 2510/244

(57) ABSTRACT

Vehicle storage processing of automated valet parking is performed. In the vehicle storage processing, equipment information on a vehicle storage target indicating a vehicle that is a target of the vehicle storage processing is acquired. Moreover, in the vehicle storage processing, whether a solar power generation system is included in equipment of the vehicle storage target is determined based on the equipment information. Further, in the vehicle storage processing, when the vehicle storage target corresponds to a non-solar power generation vehicle that does not include a solar power generation system as a result of determination based on the equipment information, guidance information for guiding the vehicle storage target to a parking space having a shorter sunshine duration with reference to an execution time of the vehicle storage processing is generated, based on usage information of the parking space within a predetermined area and sunshine duration information within the predetermined area.

### CROSS-REFERENCE TO RELATED APPLICATION

This application claims priority to Japanese Patent Application No. 2024-185081 filed on Oct. 21, 2024. The disclosure of the above-identified application, including the specification, drawings, and claims, is incorporated by reference herein in its entirety.

### BACKGROUND

### 1. Technical Field

The present disclosure relates to automated valet parking (AVP) of a vehicle within a predetermined area, such as a parking lot.

### 2. Description of Related Art

Japanese Unexamined Patent Application Publication No. 2022-146456 (JP 2022-146456 A) discloses a technology related to AVP. In the related art, in a case where AVP of a vehicle including a power receiver for non-contact charging is performed, the vehicle is guided to a parking space in which a power transmitter corresponding to the power receiver is installed.

### SUMMARY

AVP of a vehicle equipped with a solar power generation system will be considered. In the solar power generation system, electric power generated by a solar panel is charged to an in-vehicle battery. Therefore, in the AVP of the vehicle equipped with the solar power generation system, when the vehicle is guided to a parking space where sunlight is expected, charging of the in-vehicle battery by an operation of the system during parking is expected. However, depending on a configuration of a predetermined area, it is also assumed that there is a limit to the number of parking spaces where sunlight is expected. Therefore, even in a case where there is a limit to the number of parking spaces where sunlight is expected, there is a demand for development of a technology for guiding the vehicle equipped with the solar power generation system to such a parking space.

The present disclosure provides an AVP technology capable of guiding a vehicle equipped with a solar power generation system to such a parking space even when there is a limit to the number of parking spaces where sunlight is expected.

A first aspect of the present disclosure is a system that performs automated valet parking of a vehicle within an area that is predetermined, the system having the following features.

The system includes one or more storage devices and one or more processors. The one or more storage devices are configured to store usage information of a parking space within the area that is predetermined and sunshine duration information within the area that is predetermined.

The one or more processors are configured to perform vehicle storage processing of the automated valet parking based on information stored in the one or more storage devices.

The vehicle storage processing includes acquiring equipment information on a vehicle storage target indicating a vehicle that is a target of the vehicle storage processing,
determining whether a solar power generation system is included in equipment of the vehicle storage target based on the equipment information, and
generating, when the vehicle storage target corresponds to a non-solar power generation vehicle that does not include the solar power generation system as a result of the determination based on the equipment information, guidance information for guiding the vehicle storage target to a parking space having a shorter sunshine duration with reference to an execution time of the vehicle storage processing, based on the usage information and the sunshine duration information.

A second aspect of the present disclosure is a method of causing a computer to perform automated valet parking of a vehicle within an area that is predetermined, the method having the following features.

The method includes
acquiring usage information of a parking space within the area that is predetermined and sunshine duration information within the area that is predetermined,
acquiring equipment information on a vehicle storage target indicating a vehicle that is a target of vehicle storage processing of the automated valet parking,
determining whether a solar power generation system is included in equipment of the vehicle storage target based on the equipment information, and
generating, when the vehicle storage target corresponds to a non-solar power generation vehicle that does not include the solar power generation system as a result of the determination based on the equipment information, guidance information for guiding the vehicle storage target to a parking space having a shorter sunshine duration with reference to an execution time of the vehicle storage processing, based on the usage information and the sunshine duration information.

According to the first or second aspect, the non-solar power generation vehicle can be guided to the parking space having a shorter sunshine duration. Therefore, it is possible to secure the number of such parking spaces, even when there is a limit to the number of parking spaces having a longer sunshine duration. That is, even in a case where there is a limit to the number of parking spaces in which the sunlight is expected, it is possible to guide the solar power generation vehicle to such a parking space.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an automated valet parking system;

FIG. 2 is a conceptual diagram illustrating a first vehicle storage processing according to the embodiment;

FIG. 3 is a flowchart showing a processing example related to the first vehicle storage processing;

FIG. 4 is a conceptual diagram illustrating rearrangement processing according to the embodiment;

FIG. 5 is a flowchart showing a processing example related to the rearrangement processing;

FIG. 6 is a conceptual diagram illustrating a second vehicle storage processing according to the embodiment; and

FIG. 7 is a flowchart showing a processing example related to the second vehicle storage processing.

### DETAILED DESCRIPTION OF EMBODIMENTS

Hereinafter, embodiments of the present disclosure will be described with reference to the drawings. In the drawings, the same or corresponding portions are represented by the same reference numerals and description thereof will be simplified or will not be repeated.

### 1. Entire Configuration Example of System

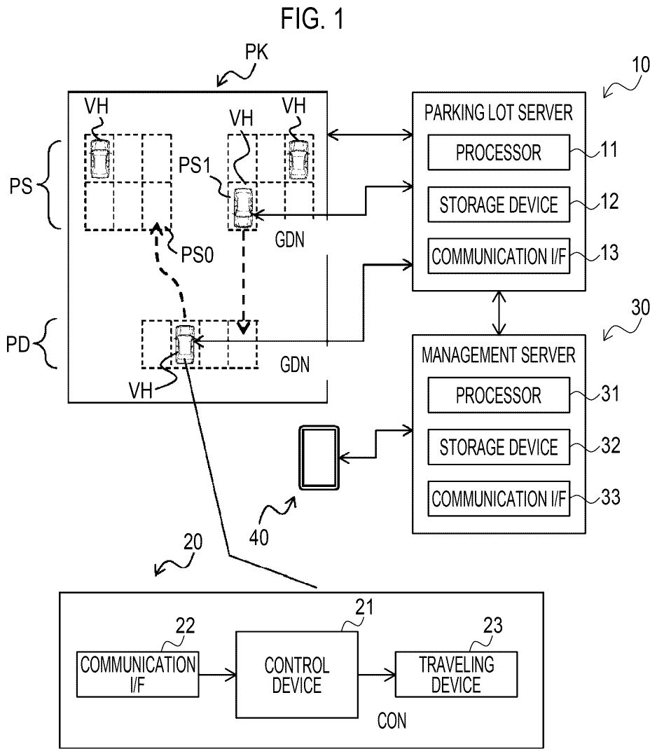

An automated valet parking system (AVP system) is a system that automatically performs a parking operation of a vehicle within a predetermined area such as a parking lot, a factory, or a facility. FIG. 1 is a diagram showing a configuration example of an AVP system. FIG. 1 shows a parking lot PK as a predetermined area. The parking lot PK has a configuration capable of executing the AVP. A configuration in which the AVP can be executed includes a pick-up and drop-off space PD and a parking space PS. The pick-up and drop-off space PD is a space for either getting off a vehicle VH, getting on the vehicle VH, or both. The parking space PS is a space for parking the vehicle VH. The parking space PS includes a parking space PS0 in an empty state and a parking space PS1 in a used state. The AVP-executable configuration also includes a marker that assists in the movement of the vehicle VH in the parking lot PK, sensors (for example, a camera and a radar) that monitor the vehicle VH, and the like.

FIG. 1 also shows a server 10 (hereinafter, also referred to as a “parking lot server”) that manages the AVP in the parking lot PK. The parking lot server 10 performs various types of processing related to the management of the operation authority of the vehicle VH needed for the AVP at the parking lot PK. The parking lot server 10 further acquires various pieces of information from the sensors of the parking lot PK, and performs various types of processing related to the execution of the AVP in the parking lot PK based on the various pieces of information. The parking lot server 10 may be a combination of a server (local server) that performs various types of processing related to the execution of the AVP and a server (cloud server) that performs various types of processing related to the management of the AVP.

The parking lot server 10 is typically a computer including at least one processor 11, at least one storage device 12, and a communication interface (I/F) 13. The processor 11 has a configuration corresponding to “one or more processors” of the present disclosure. The processor 11 executes various types of processing. Examples of the processor 11 include a central processing unit (CPU), a graphics processing unit (GPU), an application specific integrated circuit (ASIC), and a field-programmable gate array (FPGA). The processor 11 can also be referred to as “circuitry” or “processing circuitry”. The “circuitry” is hardware programmed to implement functions described or hardware that executes the functions. The processor 11 reads out various pieces of information from the storage device 12 and stores various pieces of information in the storage device 12.

The storage device 12 has a configuration corresponding to the “one or more storage devices” of the present disclosure. The storage device 12 includes a volatile memory, a non-volatile memory, a hard disk drive (HDD), a solid state drive (SSD), and the like. Examples of various pieces of information stored in the storage device 12 include parking lot map information, parking lot usage information, vehicle management information, and sunshine duration information.

The parking lot map information indicates map information of the parking lot PK. The parking lot usage information is information regarding the use status (vacancy information) of the pick-up and drop-off space PD and the parking space PS in the parking lot PK. The vehicle management information includes information such as a vehicle ID, an in/out time, and a vehicle position. The vehicle management information is managed for each vehicle VH. The vehicle ID is identification information of the vehicle VH. The in-out time is information on the time of the in-out of the vehicle VH (for example, reservation time and actual time). The vehicle position indicates information on a position of the vehicle VH in the parking lot PK. The sunshine duration information is information on the sunshine duration SD in the parking lot PK, and is managed for each parking space PS. The sunshine duration SD is calculated, for example, every day based on the sunshine factor. Examples of the sunlight factor include meteorological information, configuration information of the parking lot PK (position and information of the structure), surrounding information of the parking lot PK (position and height of the surrounding structure), and vehicle information of the vehicle parked around the parking space PS (parking position of the parked vehicle and vehicle height of the parked vehicle).

The communication I/F 13 is an interface for transmitting and receiving information by communicating with a device outside the parking lot server 10. For example, the communication I/F 13 is configured by a device for connecting to the surrounding device by the wireless LAN, a device for connecting to the mobile communication network, a device for connecting to the Internet, and the like. The parking lot server 10 transmits and receives information to and from the vehicle VH (vehicle system 20) via the communication I/F 13. The parking lot server 10 also transmits and receives information to and from a management server 30 via the communication I/F 13.

Further, in FIG. 1, the vehicle system 20 is shown. The vehicle system 20 is mounted on each of the vehicles VH as a system capable of executing the AVP. The vehicle system 20 includes a control device 21, a communication I/F 22, and a traveling device 23.

The control device 21 is communicably connected to the communication I/F 22 and the traveling device 23. The control device 21 is a computer that performs information processing related to the control of the vehicle VH based on various pieces of information. The control device 21 includes at least one processor and at least one storage device. A configuration example of the processor of the control device 21 is the same as that of the processor 11. In addition, a configuration example of the storage device of the control device 21 is the same as that of the storage device 12. The processor of the control device 21 cooperates with the storage device of the control device 21 to realize information processing related to the control of the vehicle VH.

For example, the control device 21 is configured by one or more electronic control units (ECUs). In another example, the control device 21 is configured by a kit (for example, an AVP kit) for the function provided by the parking lot server 10. The control device 21 generates and outputs a control signal of the vehicle VH by information processing. In a case where the vehicle VH receives guidance information GDN of the AVP operation (for example, the entry operation, the exit operation, or the rearrangement operation) from the parking lot server 10, the control device 21 generates the control signal CON for the AVP operation. The control signal CON is transmitted to the traveling device 23.

The communication I/F 22 is an interface for transmitting and receiving information by communicating with a device outside the vehicle VH. The vehicle VH transmits and receives information to and from the parking lot server 10 via the communication I/F 22. In addition, the vehicle VH can also transmit and receive information to and from a user terminal 40 via the communication I/F 22.

The traveling device 23 includes a drive device, a braking device, a steering device, and the like. Each device of the traveling device 23 includes an actuator that can be controlled by the control device 21. The traveling device 23 acquires a control signal from the control device 21. The control device 21 controls the traveling device 23 by the actuator operating in response to the control signal. In addition, the control of the vehicle VH is realized by controlling the traveling device 23. An actuator 27 operates in response to the control signal CON for the AVP operation, whereby the vehicle control for the AVP operation is realized.

Further, FIG. 1 also shows the management server 30. The management server 30 is a server (cloud server) that manages the entire AVP service. The management server 30 manages a user who uses the AVP service (hereinafter, also referred to as an “AVP user”) and a vehicle having the vehicle system 20 (that is, the vehicle VH). The management of the AVP user includes the authentication of the AVP user and the management of the reservation of the AVP by the AVP user. The management of the vehicle VH includes the management of the vehicle information of the vehicle VH, the management of the operation permission of the vehicle VH, and the management of the AVP operation log of the vehicle VH.

The management server 30 performs various types of processing related to the management of the reservation of the AVP in the parking lot PK. The management server 30 is typically a computer including at least one processor 31, at least one storage device 32, and a communication I/F 33. A configuration example of the processor 31 is the same as that of the processor 11. In addition, a configuration example of the storage device 32 is the same as that of the storage device 12.

Examples of various pieces of information stored in the storage device 32 include the AVP reservation information, the user information, and the AVP vehicle information.

The AVP reservation information is information regarding a reservation of the AVP by the AVP user. The AVP reservation information includes information such as a parking lot that the AVP user wants to use and an in/out time. The user information includes information such as a user ID of the AVP user and a vehicle ID of the vehicle used by the AVP user. The user information is managed for each AVP user. The AVP vehicle information includes information such as a vehicle ID of the vehicle having the vehicle system 20, an IP address of the vehicle system 20, and an AVP operation log by the vehicle system 20. The AVP vehicle information also includes equipment information of the vehicle having the vehicle system 20. The equipment information is information related to the in-vehicle equipment. Examples of the in-vehicle equipment include a solar power generation system including a solar panel, a converter, a battery, and the like, and an external charging system including a battery that can be charged from an external charger. In a case of a vehicle equipped with a solar power generation system or an external charging system, a state of charge SOC of the battery of the system may be included in the AVP vehicle information.

The communication I/F 33 is an interface for transmitting and receiving information by communicating with a device outside the management server 30. For example, the communication I/F 33 is configured by a device for connecting to the surrounding device by the wireless LAN, a device for connecting to the mobile communication network, a device for connecting to the Internet, and the like. The management server 30 transmits and receives information to and from the parking lot server 10 via the communication I/F 33. The management server 30 also transmits and receives information to and from the user terminal 40 via the communication I/F 33.

The user terminal 40 is a terminal carried by the AVP user (for example, a smartphone). The AVP user transmits and receives information to and from the vehicle VH (vehicle system 20) by operating the user terminal 40. The AVP user also transmits and receives information to and from the management server 30 by operating the user terminal 40. The user terminal 40 is used for the use registration or the use reservation of the AVP service by the AVP user. The user terminal 40 is also appropriately used for the AVP at the parking lot PK. Instead of the operation of the user terminal 40, the information on the AVP may be transmitted and received by the operation of the terminal (for example, HMI) mounted on the vehicle VH.

### 2. AVP Processing

When the AVP processing (vehicle storage processing) is executed, for example, the parking lot server 10 transmits and receives information to and from the management server 30 to acquire the operation permission of the vehicle VH waiting in the pick-up and drop-off space PD. By transferring the operation permission to the parking lot server 10, the AVP of the vehicle VH by the parking lot server 10 (processor 11) becomes executable. The vehicle system 20 generates the control signal CON in accordance with the guidance information GDN on the AVP operation (entrance operation) received from the parking lot server 10, and controls the traveling device 23. As a result, the vehicle control for the AVP operation (entrance operation) from the pick-up and drop-off space PD to the parking space PS0 is performed.

When the AVP processing (rearrangement processing) is performed, for example, the vehicle system 20 generates the control signal CON in accordance with the guidance information GDN of the AVP operation (rearrangement operation) received from the parking lot server 10, and controls the traveling device 23. As a result, the vehicle control for the AVP operation (rearrangement operation) from the parking space PS1 to the parking space PS0 is performed.

When the AVP processing (retrieval processing) is performed, for example, the vehicle system 20 generates the control signal CON in accordance with the guidance information GDN of the AVP operation (retrieval operation) received from the parking lot server 10, and controls the traveling device 23. As a result, the vehicle control for the AVP operation (pick-up operation) from the parking space PS1 to the pick-up and drop-off space PD is performed. When the vehicle VH arrives at the pick-up and drop-off space PD, the parking lot server 10 transmits and receives information to and from the management server 30 to return the operation permission of the vehicle VH. By transferring the operation permission to the management server 30, the execution of the AVP of the vehicle VH by the parking lot server 10 (processor 11) ends.

### 3. Features of AVP Processing

### 3-1. Features of First Vehicle Storage Processing

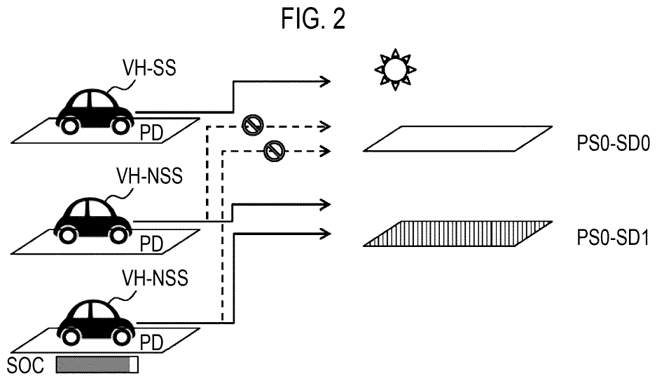

FIG. 2 is a conceptual diagram illustrating a first vehicle storage processing according to the embodiment. FIG. 2 shows two types of vehicles VH. On one hand, the vehicle VH includes a solar power generation system (hereinafter, also referred to as a “vehicle VH-SS”), and on the other hand, the vehicle VH does not include the solar power generation system (hereinafter, also referred to as a “vehicle VH-NSS”). The vehicle VH-SS corresponds to the “solar power generation vehicle” of the present disclosure, and the vehicle VH-NSS corresponds to the “non-solar power generation vehicle” of the present disclosure.

In the first vehicle storage processing, the parking positions of the vehicle VH-SS and the vehicle VH-NSS are any of the parking spaces PS0. Note that the parking space PS0 includes a parking space PS0 (hereinafter, also referred to as a “sunlit parking space PS0-SD0”) where sunlight is expected and a parking space PS0 (hereinafter, also referred to as a “shaded parking space PS0-SD1”) where sunlight is not expected. Here, the distinction between the sunlit place and the shaded place is set according to the length of the sunshine duration SD. For example, the parking space PS0 in which the sunshine duration SD is longer than the designated duration DD (Designated Duration) belongs to a “sunlit parking space PS0-SD0”. The parking space PS0 in which the sunshine duration SD is shorter than the designated duration DD belongs to the “shaded parking space PS0-SD1”. In this way, the sunlit side and the shaded side are distinguished.

In a case where the vehicle VH-SS can be parked in the sunlit parking space PS0-SD0, the battery is expected to be charged by the operation of the solar power generation system during parking. However, in a case where the vehicle VH-NSS is parked in the sunlit parking space PS0-SD0 , the parking opportunity of the vehicle VH-SS in the sunlit parking space PS0-SD0 is taken away. Therefore, in the first vehicle storage processing, when the vehicle VH (hereinafter, also referred to as “vehicle storage target LT”) that is the target of the vehicle storage processing corresponds to the vehicle VH-NSS, the parking position of the vehicle storage target LT is set to the shaded parking space PS0-SD1 . As a result, the parking opportunity of the vehicle VH-SS other than the vehicle VH-SS that is the vehicle storage target LT is secured to the sunlit parking space PS0-SD0 .

In addition, in a case where the vehicle storage target LT is the vehicle VH-SS, the state of charge SOC of the battery of the solar power generation system of the vehicle storage target LT may be sufficient. In such a case, the parking opportunity of another vehicle VH-SS having an insufficient state of charge SOC is deprived in the sunlit parking space PS0-SD0. Therefore, in the first vehicle storage processing, when the information on the state of charge SOC of the vehicle storage target LT is available and the state of charge SOC is sufficient, the parking position of the vehicle storage target LT may be set to the shaded parking space PS0-SD1. As a result, the parking opportunity of the other vehicle VH-SS having the insufficient state of charge SOC in the sunlit parking space PS0-SD0 is secured.

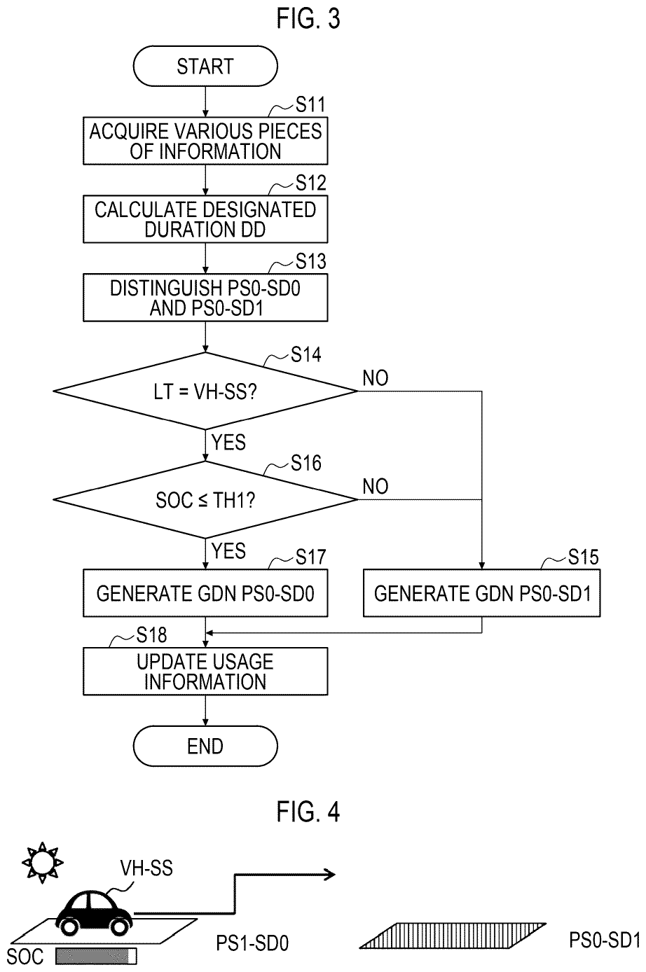

FIG. 3 is a flowchart showing a computer processing example related to the first vehicle storage processing. The routine shown in FIG. 3 is executed by the parking lot server 10 (processor 11) shown in FIG. 1. The routine shown in FIG. 3 is started, for example, at the timing when the vehicle storage target LT reaches the pick-up and drop-off space PD.

In the routine shown in FIG. 3, first, various pieces of information are acquired (S11). Examples of the various pieces of information include parking lot map information, parking lot usage information, vehicle management information, and sunshine duration information stored in the storage device 12. In addition, various pieces of information also include the AVP reservation information, the user information, and the AVP vehicle information (equipment information and information on the state of charge SOC) related to the vehicle storage target LT stored in the storage device 32, as an example.

Following the processing of S11, a designated duration DD is calculated (S12). The designated duration DD is calculated based on the execution time ET of the vehicle storage processing. For example, when the execution time ET is after the sunset and before the sunrise, the sunlight of the vehicle storage target LT during parking is expected from the sunrise to the sunset. Therefore, in this case, the designated duration DD is calculated based on the daytime (for example, about four hours before and after noon). When the execution time ET is after sunrise and before sunset, the sunshine of the vehicle storage target LT during parking is expected to be after the vehicle stops in the parking space PS. Therefore, in this case, the designated duration DD is calculated based on the time of sunset based on the execution time ET.

Subsequent to the processing of S12, the parking space PS0 is distinguished from the sunlit parking space PS0-SD0 and the shaded parking space PS0-SD1 (S13). In the processing of S13, first, the sunshine duration SD of the parking space PS0 is specified based on the parking lot usage information and the sunshine duration information acquired in the processing of S11. Then, the specified sunshine duration SD and the designated duration DD calculated in the processing of S12 are compared. Then, the parking space PS0 having the sunshine duration SD longer than the designated duration DD is set as the sunlit parking space PS0-SD0. On the other hand, the parking space PS0 having the sunshine duration SD shorter than the designated duration DD is set as the shaded parking space PS0-SD1.

Subsequent to the processing of S13, determination is made as to whether the vehicle storage target LT corresponds to the vehicle VH-SS (S14). The processing of S14 is performed based on the equipment information of the vehicle storage target LT acquired in the processing of S11. As a result of the processing of S14, in a case where the determination is made that the vehicle storage target LT corresponds to the vehicle VH-SS, the processing of S16 is performed. When determination is made that the vehicle VH-SS does not correspond to the vehicle storage target LT (that is, the vehicle storage target LT corresponds to the vehicle VH-NSS), the processing of S15 is performed.

In the processing of S15, the guidance information GDN for the vehicle storage target LT is generated. The guidance information GDN is information for the entrance operation from the pick-up and drop-off space PD to the shaded parking space PS0-SD1. The generated guidance information GDN is transmitted to the vehicle storage target LT.

The processing of S16 is performed in a case where the information on the state of charge SOC of the battery of the solar power generation system of the vehicle storage target LT is obtainable. When the information on the state of charge SOC cannot be obtained, the processing of S17 is performed instead of the processing of S16. In the processing of S16, determination is made whether the state of charge SOC is equal to or less than a threshold value TH1. The threshold value (charge execution threshold value) TH1 is set in advance as a state of charge at which the battery of the solar power generation system is determined to need to be charged.

As a result of the processing of S16, when determination is made that the state of charge SOC is equal to or less than the threshold value TH1, the processing of S17 is performed. Otherwise, the processing of S15 is performed. In the processing of S17, the guidance information GDN for the vehicle storage target LT is generated. The guidance information GDN is information for the entrance operation from the pick-up and drop-off space PD to the sunlit parking space PS0-SD0. The generated guidance information GDN is transmitted to the vehicle storage target LT.

After the processing of S15 or S17, the parking lot usage information is updated (S18). By performing the processing of S18, the information on the use situation of the pick-up and drop-off space PD used by the vehicle storage target LT or the use situation of the sunlit parking space PS0-SD0 to be used by the vehicle storage target LT is updated.

### 3-2. Features of Rearrangement Processing

FIG. 4 is a conceptual diagram illustrating the rearrangement processing according to the embodiment. FIG. 4 shows a vehicle VH-SS. The vehicle VH-SS is a vehicle VH parked in a parking space PS1 (hereinafter, also referred to as a sunlit parking space PS1-SD0) where sunlight is expected. The sunlit parking space PS1-SD0 is set as a parking position of the vehicle VH-SS as the vehicle storage target LT, for example.

In the parking space PS1, in addition to the sunlit parking space PS1-SD0, a parking space PS1 (hereinafter, also referred to as a “shaded parking space PS1-SD1”) where sunlight is not expected is included. The concept of the sunlit parking space PS1-SD0 and the concept of the shaded parking space PS1-SD1 are the same as the concept of the sunlit parking space PS0-SD0 and the concept of the shaded parking space PS0-SD1.

The vehicle VH-SS parked in the sunlit parking space PS1-SD0 is charged to the battery by the operation of the solar power generation system. As a result, the state of charge SOC of the battery of the solar power generation system of the vehicle VH-SS increases. However, the vehicle VH-SS may continue to be parked in the sunlit parking space PS1-SD0 even after the state of charge SOC of the battery sufficiently increases. In that case, the parking opportunity of another vehicle VH-SS having an insufficient state of charge SOC is taken away to the sunlit parking space PS0-SD0.

Therefore, in the rearrangement processing according to the embodiment, the parking position is changed from the sunlit parking space PS1-SD0 to the shaded parking space PS0-SD1 in the following case. The first case is a case where the vehicle VH (hereinafter, also referred to as “rearrangement target RT”) that is the target of the rearrangement processing corresponds to the vehicle VH-SS parked in the sunlit parking space PS1-SD0, and the state of charge SOC of the battery of the solar power generation system of the rearrangement target RT is sufficient. By changing the parking position, the sunlit parking space PS1-SD0 used by the rearrangement target RT is switched to the sunlit parking space PS0-SD0. As a result, the parking opportunity of the vehicle VH-SS in the sunlit parking space PS0-SD0 of the vehicle VH-SS other than the vehicle VH-SS that is the rearrangement target RT is secured.

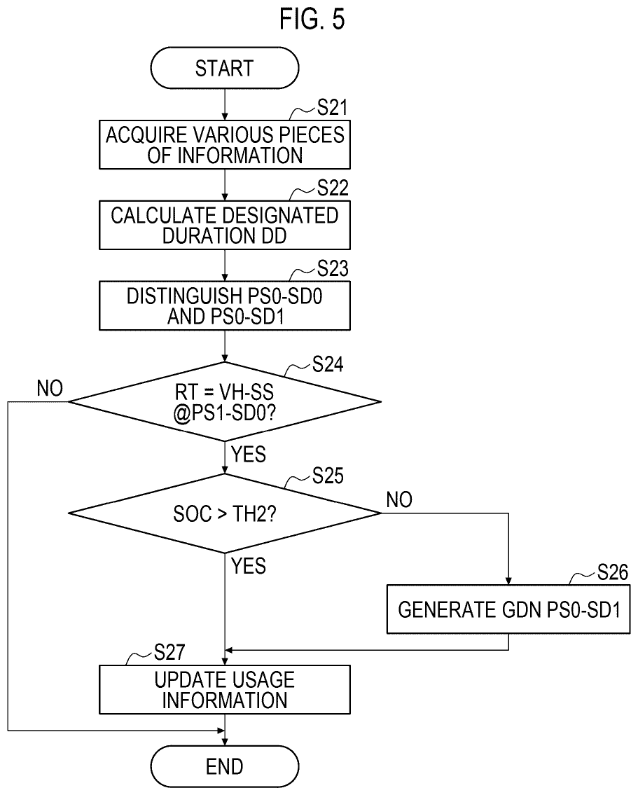

FIG. 5 is a flowchart showing a computer processing example related to the rearrangement processing. The routine shown in FIG. 5 is executed by the parking lot server 10 (processor 11) shown in FIG. 1. The routine shown in FIG. 5 is repeatedly executed at a constant cycle, for example.

In the routine shown in FIG. 5, first, the processing of S21 to S23 is executed. The contents of the processing of S21 to S23 will be described by replacing the “vehicle storage target LT” in the description of S11 to S13 in FIG. 3 with “rearrangement target RT” and replacing the “vehicle storage processing” with “rearrangement processing”. The rearrangement target RT is optionally selected from the vehicles VH parked in the parking space PS1.

Subsequent to the processing of S23, determination is made as to whether the rearrangement target RT corresponds to the vehicle VH-SS parked in the sunlit parking space PS1-SD0 (S24). The processing of S24 is performed based on the equipment information of the rearrangement target RT acquired in the processing of S21. When the determination result in S24 is affirmative (that is, when the determination is made that the rearrangement target RT corresponds to the vehicle VH-SS parked in the sunlit parking space PS1-SD0), the processing of S25 is performed. In a case other than the above (that is, in a case where the determination is made that the rearrangement target RT corresponds to the vehicle VH-NSS or the determination is made that the rearrangement target RT corresponds to the vehicle VH-SS parked in the shaded parking space PS1-SD1), the processing of the routine ends.

In the processing of S25, determination is made whether the state of charge SOC exceeds a threshold value TH2. The threshold value (charge completion threshold value) TH2 is set in advance as a state of charge at which the charging of the battery of the solar power generation system is determined to be completed (TH2>TH1). When the determination result in S25 is affirmative, the processing of S27 is performed.

When the determination result of S25 is negative, the guidance information GDN for the rearrangement target RT is generated (S26). The guidance information GDN is information for the rearrangement operation from the sunlit parking space PS1-SD0 to the shaded parking space PS0-SD1. The generated guidance information GDN is transmitted to the rearrangement target RT.

The processing of S27 is performed when the determination result of S25 is affirmative, or after the processing of S26. In the processing of S27, the parking lot usage information is updated. By performing the processing of S27, the information regarding the usage status of the sunlit parking space PS1-SD0 used by the rearrangement target RT or the usage status of the shaded parking space PS0-SD1 to be used by the rearrangement target RT is updated.

### 3-3. Features of Second Vehicle Storage Processing

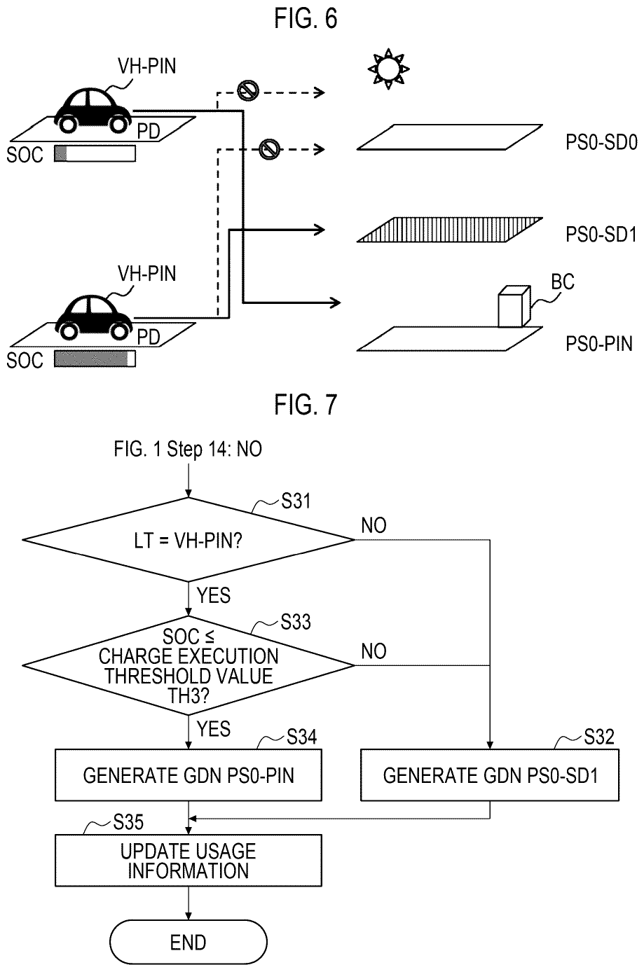

FIG. 6 is a conceptual diagram illustrating a second vehicle storage processing according to the embodiment. FIG. 6 shows a vehicle VH-PIN. The vehicle VH-PIN is a vehicle VH including an external charging system. The vehicle VH-PIN corresponds to the “external charging vehicle”of the present disclosure.

In the second vehicle storage processing, the parking position of the vehicle VH-PIN is any of the parking spaces PS0. Note that, a case where the sunlit parking space PS0-SD0 or the shaded parking space PS0-SD1 is also a parking space PO0 (hereinafter, also referred to as an “external charging parking space PS0-PIN”) including the charger BC is assumed.

When the vehicle VH-PIN can be parked in the external charging parking space PS0-PIN, the battery is expected to be charged by the operation of the external charging system during parking. However, in a case where the external charging parking space PS0-PIN also corresponds to the sunlit parking space PS0-SD0, the vehicle VH-PIN may be parked in the sunlit parking space PS0-SD0. In such a case, the parking opportunity of the vehicle VH-SS in the sunlit parking space PS1-SD0 is taken away.

Therefore, in the second vehicle storage processing, when the vehicle storage target LT corresponds to the vehicle VH-PIN, and the state of charge SOC of the battery of the external charging system of the vehicle storage target LT is sufficient, the parking position of the vehicle storage target LT is set to the shaded parking space PS0-SD1. On the other hand, when the state of charge SOC of the battery of the external charging system of the vehicle storage target LT is insufficient, the parking position of the vehicle storage target LT is set to the external charging parking space PS0-PIN. As a result, the parking opportunity of the vehicle VH-SS in the external charging parking space PS0-PIN and the sunlit parking space PS-SD0 is secured.

In the second vehicle storage processing, the parking position of the vehicle storage target LT may be set to the external charging parking space PS0-PIN and the shaded parking space PS0-SD1 when the state of charge SOC of the battery of the external charging system of the vehicle storage target LT is insufficient. In this case, the distinction between the sunlit area and the shaded area performed in the first vehicle storage processing is performed separately. Even in this case, the parking opportunity of the vehicle VH-SS in the external charging parking space PS0-PIN and the sunlit parking space PS0-SD0 is secured.

FIG. 7 is a flowchart showing a computer processing example related to the second vehicle storage processing. The routine shown in FIG. 7 is executed when the determination is made in the result of the processing of S14 in FIG. 3 that the vehicle VH-SS does not correspond to the vehicle storage target LT.

In the routine shown in FIG. 7, first, determination is made as to whether the vehicle storage target LT corresponds to the vehicle VH-PIN (S31). The processing of S31 is performed based on the equipment information of the vehicle storage target LT acquired in the processing of S11 in FIG. 3. As a result of the processing of S31, in a case where determination is made that the vehicle storage target LT corresponds to the vehicle VH-PIN, the processing of S33 is performed. When determination is made that the vehicle storage target LT does not correspond to the vehicle PIN, the processing of S32 is performed.

In the processing of S32, the guidance information GDN for the vehicle storage target LT is generated. The content of the processing of S32 is the same as that of S15 in FIG. 3.

In the processing of S33, determination is made whether the state of charge SOC of the battery of the external charging system of the vehicle storage target LT is equal to or less than a threshold value TH3. The threshold value (charge execution threshold value) TH3 is set in advance as a state of charge at which the battery of the external charging system is determined to need to be charged. The threshold value TH3 may be set to the same value as the threshold value TH1 or may be set to a different value.

As a result of the processing of S33, when determination is made that the state of charge SOC is equal to or less than the threshold value TH3, the processing of S34 is performed. Otherwise, the processing of S32 is performed. In the processing of S34, the guidance information GDN for the vehicle storage target LT is generated. The guidance information GDN is information for the entrance operation from the pick-up and drop-off space PD to the external charging parking space PS0-PIN. The generated guidance information GDN is transmitted to the vehicle storage target LT.

In the processing of S34, the information for the entrance operation to the external charging parking space PS0-PIN and the sunlit parking space PS0-SD0 may be generated by using the result of S13 in FIG. 3.

What is claimed is:

1. A system that performs automated valet parking of a vehicle within an area that is predetermined, the system comprising:
one or more storage devices configured to store usage information of a parking space within the area that is predetermined and sunshine duration information within the area that is predetermined; and
one or more processors configured to perform vehicle storage processing of the automated valet parking based on information stored in the one or more storage devices,
wherein the vehicle storage processing includes
acquiring equipment information on a vehicle storage target indicating a vehicle that is a target of the vehicle storage processing,
determining whether a solar power generation system is included in equipment of the vehicle storage target based on the equipment information, and
generating, when the vehicle storage target corresponds to a non-solar power generation vehicle that does not include the solar power generation system as a result of the determination based on the equipment information, guidance information for guiding the vehicle storage target to a parking space having a shorter sunshine duration with reference to an execution time of the vehicle storage processing, based on the usage information and the sunshine duration information.

2. The system according to claim 1, wherein the vehicle storage processing includes
acquiring, when the vehicle storage target corresponds to a solar power generation vehicle that includes the solar power generation system as the result of the determination based on the equipment information, a state of charge of a battery of the solar power generation system included in the vehicle storage target, and
generating, when the state of charge of the battery of the solar power generation system exceeds a charge execution threshold value, the guidance information for guiding the vehicle storage target to the parking space having the shorter sunshine duration with reference to the execution time of the vehicle storage processing, based on the usage information and the sunshine duration information, and generating, when the state of charge is equal to or less than the charge execution threshold value, guidance information for guiding the vehicle storage target to a parking space having a longer sunshine duration with reference to the execution time of the vehicle storage processing, based on the usage information and the sunshine duration information.

3. The system according to claim 1, wherein:
the one or more processors are configured to further perform rearrangement processing of the vehicle parked within the area that is predetermined; and
the rearrangement processing includes
acquiring, when a rearrangement target indicating a vehicle that is a target of the rearrangement processing corresponds to a solar power generation vehicle parked in a parking space having a longer sunshine duration with reference to an execution time of the rearrangement processing, a state of charge of a battery of a solar power generation system included in the rearrangement target, and
generating, when the state of charge of the battery of the solar power generation system exceeds a charge completion threshold value, guidance information for guiding the rearrangement target to a parking space having a shorter sunshine duration with reference to the execution time of the rearrangement processing, based on the usage information and the sunshine duration information.

4. The system according to claim 1, wherein:
the parking space within the area that is predetermined includes a parking space with a charger; and
the vehicle storage processing includes
determining, when the vehicle storage target corresponds to the solar power generation vehicle, whether an external charging system is included in the equipment of the vehicle storage target based on the equipment information,
acquiring, when determination is made that the vehicle storage target corresponds to an external charging vehicle that includes the external charging system as the result of the determination based on the equipment information, a state of charge of a battery of the external charging system included in the vehicle storage target, and
generating, when the state of charge of the battery of the external charging system exceeds a charge execution threshold value, the guidance information for guiding the vehicle storage target to the parking space having the shorter sunshine duration with reference to the execution time of the vehicle storage processing, based on the usage information and the sunshine duration information, and generating, when the state of charge is equal to or less than the charge execution threshold value, guidance information for guiding the vehicle storage target to the parking space with the charger, based on the usage information.

5. A method of causing a computer to perform automated valet parking of a vehicle within an area that is predetermined, the method comprising:
acquiring usage information of a parking space within the area that is predetermined and sunshine duration information within the area that is predetermined;
acquiring equipment information on a vehicle storage target indicating a vehicle that is a target of vehicle storage processing of the automated valet parking;
determining whether a solar power generation system is included in equipment of the vehicle storage target based on the equipment information; and
generating, when the vehicle storage target corresponds to a non-solar power generation vehicle that does not include the solar power generation system as a result of the determination based on the equipment information, guidance information for guiding the vehicle storage target to a parking space having a shorter sunshine duration with reference to an execution time of the vehicle storage processing, based on the usage information and the sunshine duration information.
